(19) United States
(12) Patent Application Publication
(10) Pub. No.: US 2019/0080497 A1
(43) Pub. Date: Mar. 14, 2019

(54) METHOD AND APPARATUS FOR GENERATING MIXED REALITY CONTENTS

(71) Applicant: Macron Co., Ltd., Seongnam (KR)

(72) Inventor: Kil-Jae Lee, Seongnam (KR)

(73) Assignee: Macron Co., Ltd.

(21) Appl. No.: 16/128,625

(22) Filed: Sep. 12, 2018

(30) Foreign Application Priority Data
Sep. 13, 2017 (KR) 10-2017-0117207

(51) Int. Cl. G06T 11/60; G06T 7/194; G06T 7/90; G06T 7/13; G06T 11/00; G09G 5/377; G06K 7/14; G06K 7/10

(52) U.S. Cl. CPC G06T 11/60; G06T 7/194; G06T 7/90; G06T 7/13; G09G 2380/06; G09G 5/377; G06K 7/1417; G06K 7/10722; G06T 2207/20221; G06T 11/001

(57) ABSTRACT

Provided is a method and apparatus for generating mixed reality contents. The method includes capturing an object with an advertising board that includes a background part formed of a first color and a line-form advertising part formed of a second color in a background and generating a first image; extracting and removing the background part from the first image; extracting the line-form advertising part; regarding the extracted line-form advertising part as the background part and removing the background part when the second color is identical to a predetermined color; obtaining a second image, in which the background part and the advertising part are removed; and obtaining a third image, which is a background image, and combining the images.

### CROSS-REFERENCE TO RELATED PATENT APPLICATION

This application claims the benefit of Korean Patent Application No. 10-2017-0117207, filed on Sep. 13, 2017, the disclosure of which is incorporated herein in its entirety by reference.

### BACKGROUND

### 1. Field of the Invention

The present invention relates to a method and apparatus for generating mixed reality contents, and more particularly, to a method and apparatus for generating mixed reality contents by obtaining an image with an advertising board that includes a background part and a line-form advertising part in a background and obtaining an object by removing the background and the line-form advertising part.

### 2. Description of the Related Art

Recently, generating photos or advertisements using mixed reality (e.g., augmented reality) technology is widely prevalent. In the mixed reality technology, a real image is combined with a virtual reality image to provide a user an experience that the user is present at other places or virtual reality spaces.

One of the methods to generate mixed reality contents is chromakey that uses a green screen. After an image having a background, which is a green screen, is obtained, the green part is separated as a background to obtain an object, the object is combined with other images, and the mixed reality contents is generated.

A digital signage draws customers' interest. The mixed reality technology has the power to attract customers. In general digital signage, a camera is installed to a display device, and photos are taken and combined when a customer disposes in front of the digital signage.

However, to generate mixed reality contents by using chromakey, a green background board is needed and thus, the green background board needs to be separately installed at the other side of digital signage. Such separate installation may block pedestrians' way or may have space restraints.

### SUMMARY

The present invention provides a method and apparatus for generating mixed reality contents after obtaining an image with an advertising board that includes a background part and a line-form advertising part in a background, obtaining an object by removing the background part and the advertising part, obtaining a background image, and combining the object with the background image.

According to an aspect of the present invention, a method of generating mixed reality contents may include capturing an object with an advertising board comprising a background part formed of a first color and a line-form advertising part formed of a second color and generating a first image; extracting and removing the background part from the first image; extracting the line-form advertising part; when the second color is identical to a predetermined color, regarding the extracted line-form advertising part as the background part and removing the line-form advertising part; and obtaining a second image, in which the background part and the advertising part are removed.

The method may further include obtaining a third image, which is a background image, based on an input; and generating a fourth image by combining the second image with the third image. When the advertising board is a display screen mixed reality contents, the method may further include converting the background part into the first color based on a preset input. The advertising part may have a thickness less than a regular thickness. In the extracting the line-form advertising part, a morphology closing operation and an image differentiating technique may be used. In the obtaining a third image, which is a background image, based on an input, a two-dimensional code or a three-dimensional code attached on the advertising board may be used.

The method may further include extracting edges of each adverting board, when a plurality of advertising boards is connected to each other; and regarding the extracted edges as the background part and removing the background part, when a color of the extracted edges is identical to a predetermined color.

According to another aspect of the present invention, a method of generating mixed reality contents may include converting an advertisement display image into a background part formed of a third color only, based on a preset input; generating a fifth image after capturing an object with the background part in a background; extracting and removing the background part from the fifth image; obtaining a sixth image, in which the background part is removed; obtaining a seventh image, which is a background image, based on an input; and generating an eighth image by combining the sixth image with the seventh image.

According to another aspect of the present invention, an apparatus for generating mixed reality contents may include an image obtaining unit for generating a first image after capturing an object with an advertising board comprising a background part formed of a first color and a line-form advertising part formed of a second color in a background; and a background part extraction unit for extracting and removing the background part from the first image, extracting the line-form advertising part, regarding the extracted line-form advertising part as the background part, removing the line-form advertising part when the second color is identical to a predetermined color, wherein the image obtaining unit obtains a second image, in which the background part and the advertising part are removed.

The apparatus may further include a background image obtaining unit for obtaining a third image, which is a background image, based on an input; and a controller for generating a fourth image by combining the second image with the third image.

According to another aspect of the present invention, an apparatus for generating mixed reality contents may include a controller for converting an advertisement display image into a background part formed of a third color only, based on a preset input; an image obtaining unit for generating a fifth image after capturing an object with the background part in a background; a background part extraction unit for extracting and removing the background part from the fifth image and obtaining a sixth image, in which the background part is removed; and a background image obtaining unit for obtaining a seventh image, which is a background image, based on an input, wherein the controller generates an eighth image by combining the sixth image with the seventh image.

### BRIEF DESCRIPTION OF THE DRAWINGS

The above and other features and advantages of the present invention will become more apparent by describing in detail exemplary embodiments thereof with reference to the attached drawings in which:

FIG. 1 is a flow chart illustrating a method of generating mixed reality contents according to an exemplary embodiment of the present invention;

FIG. 2 is an example of an advertising board according to an exemplary embodiment of the present invention;

FIG. 3 is an example of a first image according to an exemplary embodiment of the present invention;

FIG. 4 is an example of an image illustrating that a background part is removed from the first image according to an exemplary embodiment of the present invention;

FIG. 5 is an image illustrating that a line-form advertising part having a thickness less than a regular thickness is filled in the image of FIG. 4 according to an exemplary embodiment of the present invention;

FIG. 6 is an example of a differential image according to an exemplary embodiment of the present invention;

FIG. 7 is an example of an image illustrating that only an object remains after a background part and an advertising part are removed according to an exemplary embodiment of the present invention;

FIG. 8 is an example of a background image according to an exemplary embodiment of the present invention;

FIG. 9 is an example of mixed reality contents in which an extracted object image is combined with a background image according to an exemplary embodiment of the present invention;

FIG. 10 is a flow chart illustrating a method of generating mixed reality contents according to another exemplary embodiment of the present invention;

FIG. 11 is an example of an advertising board according to an exemplary embodiment of the present invention;

FIG. 12 is an example of a display changed into a background image; and

FIG. 13 is a block diagram of an apparatus for generating mixed reality contents according to an exemplary embodiment of the present invention.

### DETAILED DESCRIPTION

Advantages and features of the present invention and methods of achieving the same will become apparent with reference to the exemplary embodiments described in detail below in conjunction with the accompanying drawings. However, the present invention is not limited to the exemplary embodiments disclosed below, but may be provided in various different forms. The present exemplary embodiments are merely provided to make the disclosure complete and to fully inform the category of the disclosure to a person having ordinary knowledge in the technical field to which the present disclosure pertains, and the present disclosure is only defined by the scope of the claims.

Accordingly, in some embodiments, well-known process steps, well-known structures and well-known techniques will not be specifically described to avoid ambiguous interpretation of the present invention. The terms used in the present specification are for the purpose of illustrating the examples and do not limit the present disclosure. As used herein, the singular form also includes the plural forms unless specifically stated in a phrase. The terms “comprises” and/or “comprising” used in the specification are used in the meaning of not excluding the presence or addition of one or more other constituent elements, steps, operations and/or elements, in addition to the referenced constituent elements, step, operation and/or element. Further, the term “and/or” includes each and one or more combinations of the referenced items.

Hereinafter, embodiments of the present invention will be described in more detail with reference to the accompanying drawings.

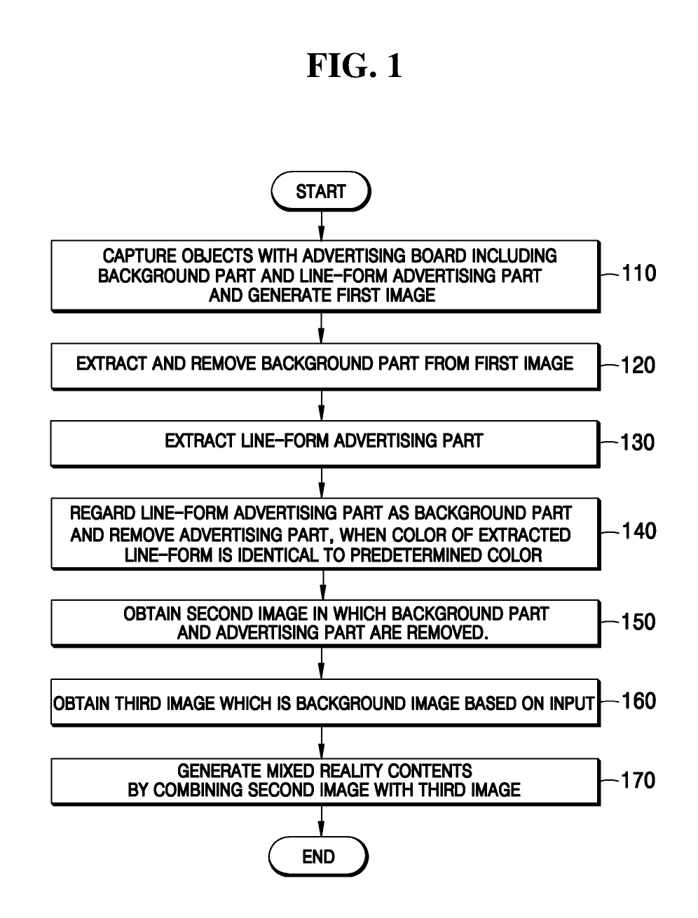

FIG. 1 is a flow chart illustrating a method of generating mixed reality contents according to an exemplary embodiment of the present invention. Referring to FIG. 1, in operations 110, an apparatus for performing a method of generating mixed reality contents (hereinafter, referred to as an ‘apparatus’) may capture an object with an advertising board that includes a background part formed of a first color and a line-form advertising part formed of a second color and thus, may generate a first image.

In the exemplary embodiment of the present invention, the advertising board may include the background part formed of the first color and the line-form advertising part formed of the second color. The first color may be green, in order to use a chromakey technique. The second color may be unrestricted and it may be different from the first color. In the exemplary embodiment of the present invention, the advertising board may be a screen of a display device. The line-form may be realized by letters and/or pictures. In the exemplary embodiment of the present invention, the line-form may have a thickness less than a regular thickness.

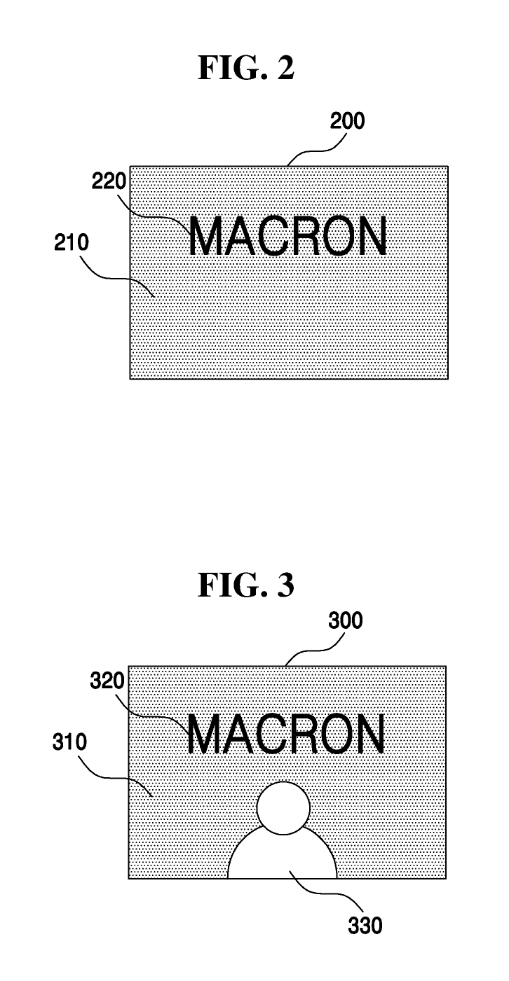

FIG. 2 is an example of an advertising board 200 according to an exemplary embodiment of the present invention. Referring to FIG. 2, the advertising board 200 may include a background part 210 and a line-form advertising part 220. The apparatus may include an imaging device such as a camera. Since an image may need to be captured with the advertising board in the background, the camera may be disposed to face the advertising board. For example, a user may use a mobile device that includes the apparatus and take a photo with the advertising board in the background by using a method of taking self-portraits (e.g., selfies). In this case, instead of using a camera installed to the advertising board, a user may use his/her own smart device and thus, may avoid privacy intrusion problems.

FIG. 3 is an example of a first image 300 according to an exemplary embodiment of the present invention. Referring to FIG. 3, the first image 300 may include a background part 310, an advertising part 320, and an object 330, which is the subject. According to another exemplary embodiment of the present invention, when an advertising board is a display screen, the apparatus may convert the background part into the first color based on a preset input. Also, the apparatus may convert the advertising part into the second color. In this case, the advertising board may be displayed in an originally intended color and may be used by changing colors of the background part or the advertising part based on a preset input, in order to generate mixed reality contents.

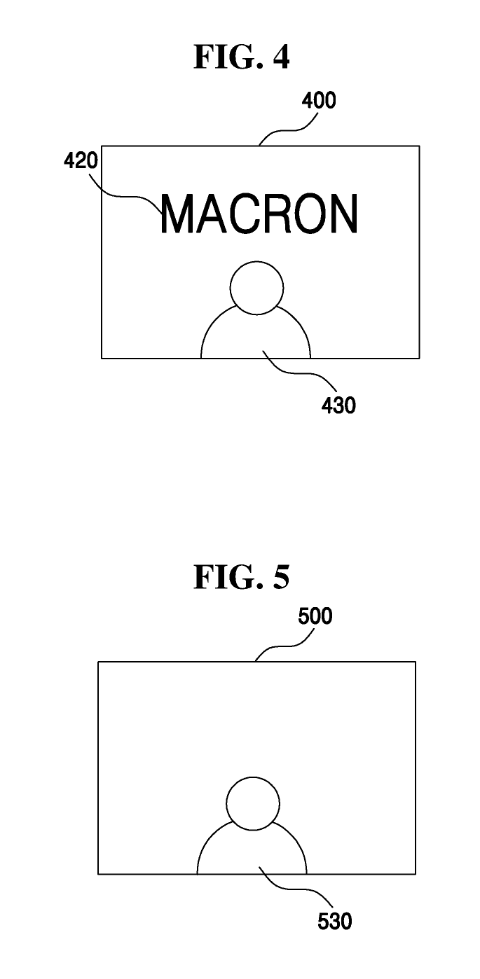

In operation 120, the apparatus may extract and remove the background part, which corresponds to the first color, from the generated first image. FIG. 4 is an example of an image 400 illustrating that the background part may be removed from the first image according to an exemplary embodiment of the present invention. Referring to FIG. 4, the image 400 from which the background part is removed from the first image may include an advertising part 420 and an object 430.

In operation 130, the apparatus may extract the line-form advertising part having a thickness less than a regular thickness. The apparatus may apply a closing operation in a morphology operation and subsequently, may use a differential image, thereby extracting a line having a thickness less than a regular thickness. The morphology operation may include a technique to reduce or expand a bright area or a dark area in an image. In an image, a white (or bright) area or a black area may be obtained wider or narrower than a desired intention. A separated area which is fault while using an optimum threshold value may be corrected through a post process.

The morphology operation may include an eroding operation, a dilation operation, an opening operation, and a closing operation, wherein the eroding operation may narrow a target area, the dilation operation may widen a target area, an opening operation may remove a particular area from a target area, and a closing operation may fill a gap. In general, the target area may indicate an area displayed in white in an image and a bright area in a gray tone image. The eroding and dilation operations may be basic operations and the opening and closing operations may be combinations of the eroding and dilation operations.

In the eroding operation, when masks are put in each pixel of an input image, a result value may be 255 when an input image has a value of 255 with respect to all pixel locations having masks of a value of 255. When any one pixel has a value of 0 at a target location, a result value may become 0 and thus, an area having a value of 255 may be overall decreased. In the dilation operation, unlike the eroding operation, all pixels in valid areas of masks may brighten. The opening and closing operations may be realized by combining the eroding operation with the dilation operation. In the opening operation, a minute pieces that appear in a bright area may be removed. The eroding operation may be firstly performed to reduce overall a bright area and then, the dilation operation may be performed to restore an overall area. By using such principle, a minute pieces may be removed.

In the closing operation, a minute gap generated in a bright area may be filled. Firstly, a dilation operation may be performed to expand the bright area and then, the eroding operation may be performed again. The area that corresponds to the gap may be filled through the dilation operation. A method of performing the opening and closing operations may sequentially perform the eroding operation and the dilation operation described above.

When the apparatus performs the closing operation in the image of FIG. 4, in which the background part is removed, the background part may be removed and thus, may correspond to a bright area. Further, since the line having a thickness less than a regular thickness may be regarded as a minute gap, the gap may be filled through the closing operation. FIG. 5 is an image illustrating that the line-form advertising part having a thickness less than a regular thickness may be filled in the image of FIG. 4 according to an exemplary embodiment of the present invention.

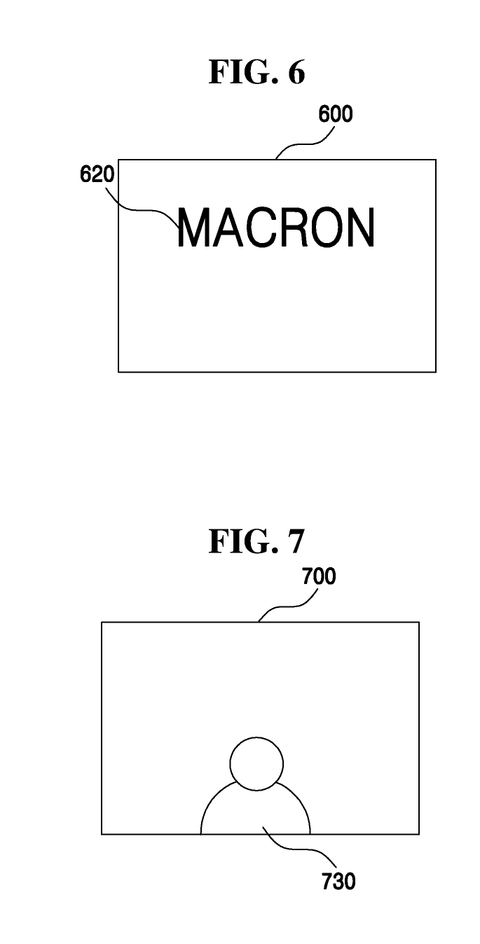

After a closing operation is performed, the apparatus may perform an image differentiating technique. The image differentiating technique may include an image processing technique used to determine changes in images. In the image differentiating technique, a difference between two images may be calculated after finding out a pixel difference of each image and an image may be generated based on the result. When the image differentiating technique is performed in the images of FIGS. 4 and 5, the apparatus may obtain a differential image in which only a line-form advertising part exists. FIG. 6 is an example of a differential image according to an exemplary embodiment of the present invention.

In operation 140, when the second color of the line-form advertising part in the extracted differential image is identical to a predetermined color, the apparatus may regard the extracted line-form advertising part as the background part and may remove the background part. When a pixel of the second color is identical or similar to a pixel of the predetermined color, the apparatus may regard the extracted line-form advertising part as the background part. Accordingly, since the advertising part is regarded as the background part, an object may solely exist.

In operation 150, the apparatus may obtain a second image from which the background part and the advertising part are removed. Accordingly, the advertising part may be used to deliver a message and may be regarded as a background when generating mixed reality contents. Thus, effective advertising may be available.

As another exemplary embodiment of the present invention, a plurality of colored lines may be overlapped with each other and used to deliver thick messages. FIG. 7 is an example of an image illustrating that only an object remains after a background part and an advertising part are removed according to an exemplary embodiment of the present invention.

In operation 160, the apparatus may obtain a third image, which may become a background image, based on an input. In an exemplary embodiment of the present invention, the third image may be selected from images that exist in a database of an application that performs a method of generating mixed reality contents in the apparatus, or images stored in the apparatus.

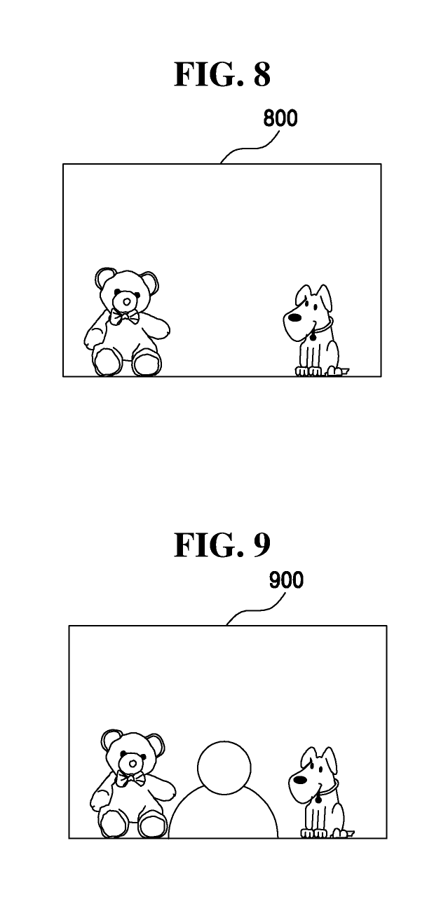

As another exemplary embodiment of the present invention, the apparatus may read a two-dimensional code or a three-dimensional code (for example, bar code or QR code) attached on the advertising board or identify a location of the advertising board using a GPS device equipped with the apparatus to obtain ID of the advertising board. Thus, based on the obtained ID, the third image may be downloaded and selected from a server. Also, the apparatus may access a server based on a two-dimensional code or a three-dimensional code attached on the advertising board and then, the third image may be downloaded and selected. FIG. 8 is an example of a background image according to an exemplary embodiment of the present invention. The background image may be advertising contents based on locations.

In operation 170, the apparatus may combine the second image with the third image to generate a fourth image. In other words, the apparatus may combine the second image, in which an object has been extracted, with the third image, which is a background image, to generate the fourth image, which is mixed reality contents. The fourth image, which is mixed reality contents, may be stored in the apparatus or may be shared with other people using social media services. Further, the apparatus may store only the second image, in which an object is extracted. In this case, a user may combine the second image with other background images. FIG. 9 is an example of mixed reality contents in which an extracted object image is combined with a background image according to an exemplary embodiment of the present invention. Accordingly, a customer may experience that he/she is in other places or virtual reality through the mixed reality contents.

As an exemplary embodiment of the present invention, in obtaining the first image, the apparatus may obtain an angle of the camera using a gyro sensor. Moreover, the apparatus may adjust an angle of the third image, which is a background image, to correspond to the angle of the camera and may combine the third image with the first image, thereby obtaining the fourth image.

Although not illustrated in the drawings, as an exemplary embodiment of the present invention, when an advertising board requires a large size, a plurality of advertising boards may be made adjacent to each other. Gaps may exist between the advertising boards due to distances between edges of the advertising boards or due to display bezels. In this case, as in operations 130 and 140, the apparatus may extract the gaps using a morphology closing operation and a differential image. When the extracted gaps correspond to a predetermined color, the apparatus may regard the extracted gaps as the background part and thus, may remove the background part. Similarly, as another exemplary embodiment of the present invention, when an advertising board is a display screen, the apparatus may regard the edge of the display as the background part and remove the background part by using the method above. In this case, even if a field of view of the camera is partly out of the advertising board, the apparatus may operate without problems and mixed reality contents may be generated in a smaller advertising board.

According to an exemplary embodiment of the present invention, when a mobile device including the apparatus moves, corresponding parts from 360° background video contents may be mixed to allow a user to experience as if the user takes selfies at the other places. In this case, to expand a radius of rotation of a camera, a larger advertising board may be needed and the advertising board may be bent to expand a radius of rotation. In particular, an advertising board having a curvature may be used or an advertising board having a corner that is bent at about a right angle may be used.

According to another exemplary embodiment of the present invention, coupons may be provided to users who generate mixed reality contents to allow the users to use the coupons at the place where the corresponding advertising board is installed or elsewhere. In this case, users may obtain a financial benefit as the coupons are provided. Additionally, for advertisers, customers may be attracted to the advertising board and promotional effect may be achieved by providing the coupons.

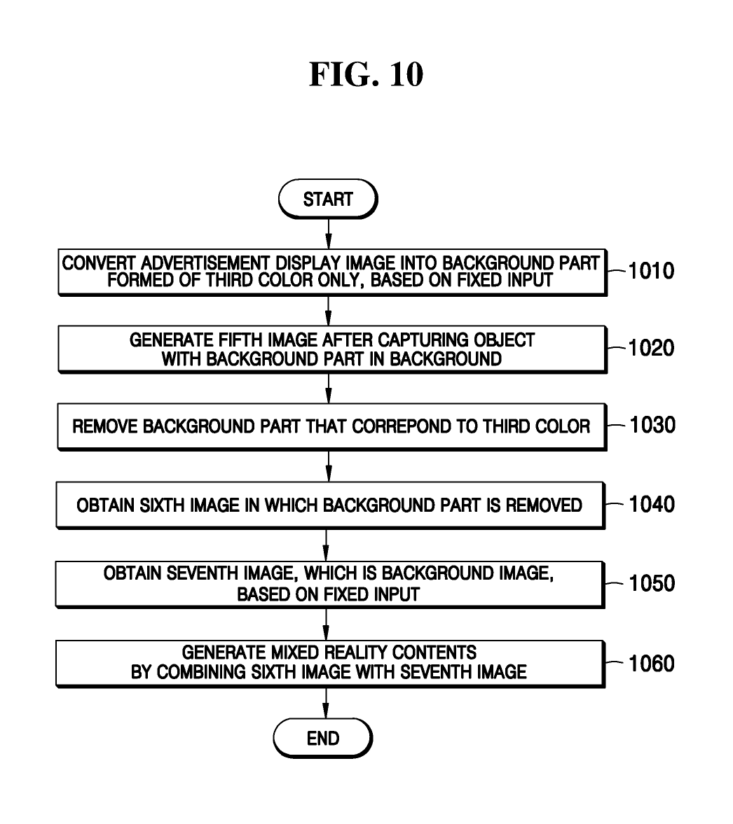

FIG. 10 is a flow chart illustrating a method of generating mixed reality contents according to another exemplary embodiment of the present invention. Referring to FIG. 10, in operation 1010, the apparatus may convert an advertising display screen into a background image formed of a third color based on a preset input signal. For example, the third color may be green to use a chromakey technique.

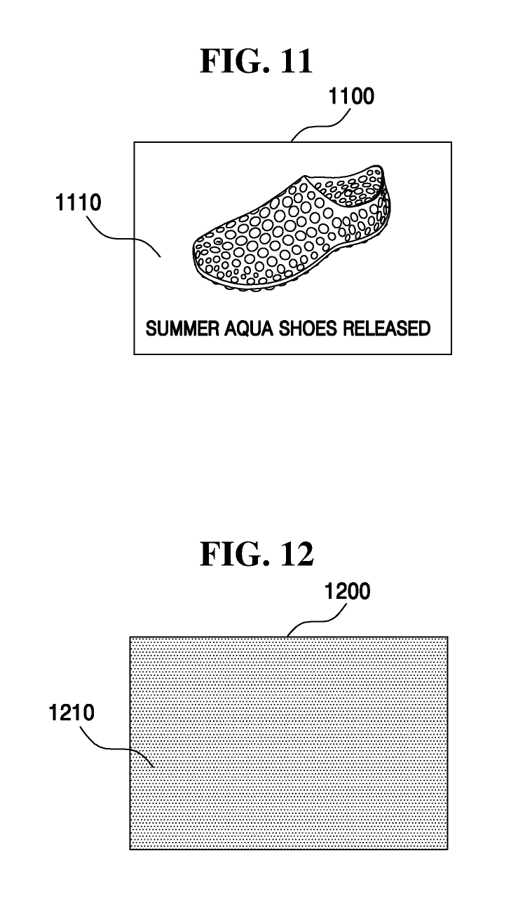

FIG. 11 is an example of an advertising board according to an exemplary embodiment of the present invention and FIG. 12 is an example of a display changed into a background image. Referring to FIGS. 11 and 12, a display image 1100, which is an advertising board, may display an advertisement 1110 and a display image 1200 may be converted into a background part 1210 upon receiving a preset input signal. The preset input signal may be generated by using a button equipped with a display image or a nearby display image or may be generated through an application that performs a method of generating mixed reality contents.

In operation 1020, the apparatus may capture an object with the converted background part in the background and may generate a fifth image. The apparatus may include an imaging device such as a camera. Since an image may need to be captured with the converted background part in the background, the camera may be disposed to face the advertising board. For example, a user may use a mobile device that includes the apparatus and take a photo with the advertising board in the background by using a method of taking self-portraits (e.g., selfies). Additionally, instead of using a camera installed to the advertising board, a user may use his/her own smart device and thus, may avoid privacy intrusion problems.

In operation 1030, the apparatus may extract and remove the background part, which corresponds to the third color, from the generated fifth image. In operation 1040, the apparatus may obtain a sixth image, in which the background part is removed. The obtained sixth image may be equivalent to the second image illustrated in FIG. 7. Accordingly, the advertising part may be used to deliver a message and may also be regarded as a background when generating mixed reality contents. Thus, effective advertising may be available.

In operation 1050, the apparatus may obtain a seventh image, which may become a background image, based on an input. The obtained seventh image may be equivalent to the third image illustrated in FIG. 8. As an exemplary embodiment of the present invention, the seventh image may be selected from images that exist in a database of an application that performs a method of generating mixed reality contents in the apparatus, or from images stored in the apparatus.

As another exemplary embodiment of the present invention, the apparatus may read a two-dimensional code or a three-dimensional code (for example, bar code or QR code) attached on the advertising board or identify a location of the advertising board using a GPS device equipped with the apparatus to obtain ID of the advertising board. Thus, based on the obtained ID, the seventh image may be downloaded and selected from a server. Also, the apparatus may access a server based on a two-dimensional code or a three-dimensional code attached on the advertising board and then, the seventh image may be downloaded and selected.

In operation 1060, the apparatus may combine the sixth image with the seventh image to generate an eighth image. In other words, the apparatus may combine the sixth image, in which an object is extracted, with the seventh image, which is a background image, to generate the eighth image, which is mixed reality contents. The eighth image, which is mixed reality contents, may be stored in the apparatus or may be shared with other people using social media services. The obtained eighth image may be equivalent to the fourth image of FIG. 4. Additionally, the apparatus may store sixth image, in which an object is extracted. In this case, a user may combine the sixth image with other background images. Accordingly, a customer may experience that he/she is in other places or virtual reality through the mixed reality contents.

As an exemplary embodiment of the present invention, in obtaining the fifth image, an angle of a camera included in the apparatus may be obtained using a gyro sensor. Further, an angle of the seventh image, which is a background image, may be adjusted to correspond to the angle of the camera and the seventh image may be combined with the sixth image, thereby obtaining the eighth image.

According to an exemplary embodiment of the present invention, when a mobile device that includes the apparatus moves, corresponding parts from the 360° background video contents may be mixed to allow a user to experience as if the user takes selfies at other places. In order to expand a radius of rotation of a camera, a larger advertising board may be needed and the advertising board may be bent to expand a radius of rotation. In particular, an advertising board having a curvature may be used or an advertising board having a corner that is bent at about a right angle may be used.

According to another exemplary embodiment of the present invention, coupons may be provided to users who generate mixed reality contents to allow the users to use the coupons at the place where the corresponding advertising board is installed or elsewhere. Accordingly, a user may obtain a financial benefit as the coupons are provided. Also, for advertisers, customers may be attracted at the advertising board and promotional effect may be achieved by providing the coupons.

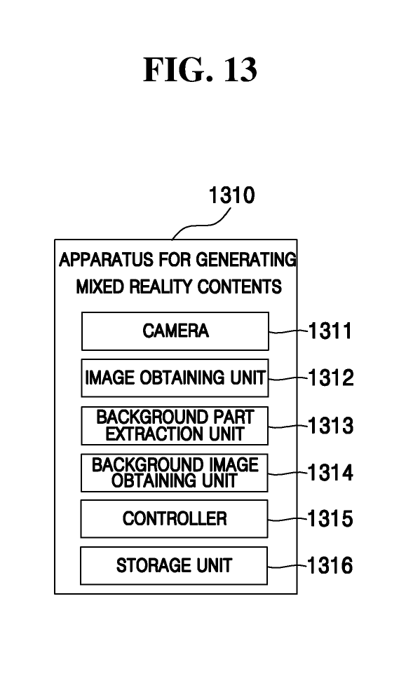

FIG. 13 is a block diagram of an apparatus 1310 for generating mixed reality contents according to an exemplary embodiment of the present invention. Referring to FIG. 13 the apparatus 1310 for generating mixed reality contents may include a camera 1311, an image obtaining unit 1312, a background part extraction unit 1313, a background image obtaining unit 1314, a controller 1315, and a storage unit 1316.

The camera 1311 may take an object with an advertising board 1320 that includes a background part formed of a first color and a line-form advertising part formed of a second color in the background and subsequently, the image obtaining unit 1312 may generat a first image. The advertising board may include the background part formed of the first color and the line-form advertising part formed of the second color. The first color may be green, in order to use a chromakey technique. The second color may be unrestricted and it may be different from the first color. The advertising board 1320 may be a screen of a display device. The line-form may be realized by letters or pictures. In the exemplary embodiment of the present invention, the line-form may have a thickness less than a regular thickness.

Since an image may need to be captured with the advertising board 1320 in the background, the camera 1311 may be disposed to face the advertising board 1320. For example, a user may use a mobile device that includes the apparatus 1310 for generating mixed reality contents and take a photo with the advertising board 1320 in the background by using a method of taking self-portraits (e.g., selfies). In this case, instead of using a camera installed to the advertising board 1320, a user may use his/her own smart device and thus, may avoid privacy intrusion problems.

For example, when an advertising board 1320 is a display screen, the controller 1315 may convert the background part into the first color based on a preset input. In addition, the controller 1315 may convert the advertising part into the second color. In this case, the advertising board 1320 may be displayed in an originally intended color and may be used by changing colors of the background part or the advertising part based on a preset input, in order to generate mixed reality contents.

The background part extraction unit 1313 may extract and remove the background part, which corresponds to the first color, from the generated first image. The background part extraction unit 1313 may extract the line-form advertising part having a thickness less than a regular thickness. The background part extraction unit 1313 may apply a closing operation of the morphology operation and then, use a differential image, thereby extracting a line having a thickness less than a regular thickness. After the background part is extracted and removed and then, a closing operation is performed, the background part extraction unit 1313 may perform an image differentiating technique.

Subsequently, when the second color of the line-form advertising part in the extracted differential image is identical to a predetermined color, the background part extraction unit 1313 may regard the extracted line-form advertising part as a background part and may remove the background part. When a pixel of the second color is identical or similar to a pixel of the predetermined color, background part extraction unit 1313 may regard the extracted line-form advertising part as the background part. Accordingly, since the advertising part is regarded as the background part, an object may solely exist.

The image obtaining unit 1312 may obtain a second image from which the background part and the advertising part are removed. Accordingly, the advertising part may be used to deliver a message and may also be regarded as a background when generating mixed reality contents. Thus, effective advertising may be available. As another exemplary embodiment of the present invention, a plurality of colored lines may be overlapped with each other and used to deliver thick messages.

The background image obtaining unit 1314 may obtain a third image, which may become a background image, based on an input. In an exemplary embodiment of the present invention, the third image may be selected from images that exist in a database of an application that performs a method of generating mixed reality contents in the apparatus 1310, or images stored in the storage unit 1316.

As another exemplary embodiment of the present invention, the controller 1315 may read a two-dimensional code or a three-dimensional code (for example, bar code or QR code) attached on the advertising board 1320 or identify a location of the advertising board 1320 using a GPS device (not illustrated) equipped with the apparatus 1310 for generating mixed reality contents to obtain ID of the advertising board 1320. Thus, based on the obtained ID, the third image may be downloaded and selected from a server. Also, the apparatus 1310 for generating mixed reality contents may access a server based on a two-dimensional code or a three-dimensional code attached on the advertising board 1320 and then, the third image may be downloaded and selected. The background image may be advertising contents based on locations.

The controller 1315 may combine the second image with the third image to generate a fourth image. In other words, the controller 1315 may combine the second image, in which an object is extracted, with the third image, which is a background image, to generate the fourth image, which is mixed reality contents. The fourth image, which is mixed reality contents, may be stored in the storage unit 1316 or may be shared with other people using social media services. In addition, the storage unit 1316 may store the second image, in which an object is extracted. In this case, a user may combine the second image with other background images. Accordingly, a customer may experience that he/she is in other places or virtual reality through the mixed reality contents.

As an exemplary embodiment of the present invention, in obtaining the first image, the controller 1315 may obtain an angle of the camera 1311 using a gyro sensor. Further, the controller 1315 may adjust an angle of the third image, which is a background image, to correspond to the angle of the camera 1311 and may combine the third image with the first image, thereby obtaining the fourth image.

Although not illustrated in the drawings, as an exemplary embodiment of the present invention, when the advertising board 1320 requires a large size, a plurality of advertising boards 1320 may be disposed adjacent to each other. Gaps may exist between the advertising boards 1320 due to spaces between edges of the advertising boards 1320 or display bezels. In this case, the background part extraction unit 1313 may extract the gaps by using a morphology closing operation and a differential image. When the extracted gaps correspond to a predetermined color, the background part extraction unit 1313 may regard the extracted gaps as the background part and thus, may remove the background part. Similarly, as another exemplary embodiment of the present invention, when the advertising board 1320 is a display screen, the background part extraction unit 1313 may regard the edge of the display as the background part and remove the background part using the method above. In this case, even if a field of view of the camera 1311 is partly out of the advertising board 1320, the apparatus 1310 for generating mixed reality contents may be operated without problems and mixed reality contents may be generated in the smaller advertising board 1320.

According to an exemplary embodiment of the present invention, when a mobile device that includes the apparatus 1310 for generating mixed reality contents moves, corresponding parts from 360° background video contents may be mixed to allow a user to experience as if he/she takes selfies at other places. In order to expand a radius of rotation of the camera 1311, the larger advertising board 1320 may be needed and the advertising board 1320 may be bent to expand a radius of rotation. In particular, the advertising board 1320 having a curvature may be used or the advertising board 1320 having a corner that bent at about a right angle may be used.

According to another exemplary embodiment of the present invention, the apparatus 1310 for generating mixed reality contents may provide coupons to users who generate mixed reality contents to allow the users to use the coupons at the place where the corresponding advertising board 1320 is installed or elsewhere. Accordingly, users may obtain a financial benefit as the coupons are provided. In addition, for advertisers, customers may be attracted to the advertising board and promotional effect may be achieved by providing the coupons.

Hereinafter, the apparatus 1310 for generating mixed reality contents according to another exemplary embodiment of the present invention will be described in more detail.

The controller 1315 may convert an advertising display screen into a background image formed of a third color based on a preset input signal. The third color may be green in order to use a chromakey technique. The preset input signal may be generated through an application that performs a method of generating mixed reality contents. The image obtaining unit 1312 may capture an object with the converted background part in the background and generate a fifth image.

The apparatus 1310 for generating mixed reality contents may include an imaging device such as the camera 1311. Since an image may need to be captured with the converted background part in the background, the camera 1311 may be disposed to face the advertising board. For example, a user may use a mobile device that includes the apparatus 1310 for generating mixed reality contents and take a photo with the advertising board in the background using a method of taking self-portraits (e.g., selfies). Alternatively, instead of using a camera installed to the advertising board, a user may use his/her own smart device and thus, may avoid privacy intrusion problems.

The background part extraction unit 1313 may extract and remove the background part, which corresponds to the third color, from the generated fifth image. Then, the background part extraction unit 1313 may obtain a sixth image, in which the background part is removed. Accordingly, the advertising part may be used to deliver a message and may also be regarded as a background when generating mixed reality contents. Thus, effective advertising may be available.

The background image obtaining unit 1314 may obtain a seventh image, which may become a background image, based on an input. As an exemplary embodiment of the present invention, the seventh image may be selected from images that exist in a database of an application that performs a method of generating mixed reality contents in the apparatus 1310 for generating mixed reality contents, or images stored in the storage unit 1316.

As another exemplary embodiment of the present invention, the apparatus 1310 for generating mixed reality contents may read a two-dimensional code or a three-dimensional code (for example, bar code or QR code) attached on the advertising board or identify a location of the advertising board using a GPS device equipped with the apparatus 1310 for generating mixed reality contents to obtain ID of the advertising board. Thus, based on the obtained ID, the seventh image may be downloaded and selected from a server. Also, the apparatus 1310 for generating mixed reality contents may access a server based on a two-dimensional code or a three-dimensional code attached on the advertising board and then, the seventh image may be downloaded and selected.

The controller 1315 may combine the sixth image with the seventh image to generate an eighth image. In other words, the controller 1315 may combine the sixth image, in which an object is extracted, with the seventh image, which is a background image, to generate the eighth image, which is mixed reality contents. The eighth image, which is mixed reality contents, may be stored in the storage unit 1316 or may be shared with other people using social media services. Alternatively, the storage unit 1316 may store the sixth image, in which an object is extracted. In this case, a user may combine the second image with other background images. Therefore, a customer may experience that he/she is in other places or virtual reality through the mixed reality contents.

As an exemplary embodiment of the present invention, in obtaining the fifth image, the controller 1315 may obtain an angle of the camera 1311 using a gyro sensor. Further, the controller 1315 may adjust an angle of the seventh image, which is a background image, to correspond to the angle of the camera 1311 and may combine the seventh image with the sixth image, thereby obtaining the eighth image.

According to an exemplary embodiment of the present invention, when a mobile device that includes the apparatus 1310 for generating mixed reality contents moves, corresponding parts from 360° background video contents may be mixed to allow a user to experience as if he/she takes selfies at other places. In this case, in order to expand a radius of rotation of the camera 1311, a larger advertising board may be needed and the advertising board may be bent to expand a radius of rotation. For example, an advertising board having a curvature may be used or an advertising board having a corner that is bent at about a right angle may be used.

According to another exemplary embodiment of the present invention, coupons may be provided to users who generate mixed reality contents to allow the users to use the coupons at the place where the corresponding advertising board is installed or elsewhere. Therefore, users may receive a financial benefit as the coupons are provided. Also, for advertisers, customers may be attracted at the advertising board and promotional effect may be achieved by providing the coupons.

According to the present invention, a user may take selfies in front of a mixed reality advertising board using a smart device, and the user may separate a background from the taken photo and insert virtual reality contents that correspond to the background. Accordingly, the user may experience mixed reality contents. When capturing mixed reality contents including the user, the contents may be captured in user's mobile phone and thus, problems regarding privacy may be solved.

According to the present invention, unlike a general digital signage technique, a user may stand with an advertising board at his/her back to capture an image. Accordingly, the apparatus may be installed in a generally open environment, provide the user various benefits such as mixed reality contents, extracted object contents, and coupons, and also provide an advertiser increased promotional effect. Therefore, promotional effect using digital signage may be realized, promotional effect may be increased by providing coupons to a user, and personalized advertisement may be provided as a personal smart device is used.

According to the present invention, since advertising using pictures or texts having a thickness less than a regular thickness may be usually available in an advertising board with a green background, promotional effect may be improved, and an efficient and low-cost mixed reality advertising board may be provided.

Augmented reality (AR), virtual reality (VR), and mixed reality (MR) contents are expected to perform an important role in the contents market and thus, the importance of offline advertising using digital signage may grow. Accordingly, the present invention is well prepared.

The method of generating mixed reality contents described above may be embodied as computer readable codes on a computer readable recording medium. The computer readable recording medium may include any data storage device that can store data which may be thereafter read by a computer system. Examples of the computer readable recording medium include read-only memory (ROM), random-access memory (RAM), CD-ROMs, magnetic tapes, floppy disks, and optical data storage devices. The computer readable recording medium may also be distributed over network coupled computer systems to allow the computer readable code to be stored and executed in a distributed fashion. In addition, functional programs, codes, and code segments for accomplishing the present invention may be easily construed by programmers skilled in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of generating mixed reality contents, comprising:
capturing an object with an advertising board that includes a background part formed of a first color and a line-form advertising part formed of a second color and to generate a first image;
extracting and removing the background part from the first image;
extracting the line-form advertising part;
regarding the extracted line-form advertising part as the background part and removing the line-form advertising part when the second color is identical to a predetermined color; and
obtaining a second image, in which the background part and the advertising part are removed.

2. The method of claim 1, further comprising:
obtaining a third image, which is a background image, based on an input; and
generating a fourth image by combining the second image with the third image.

3. The method of claim 2, further comprising:
converting the background part into the first color based on a preset input signal, when the advertising board is a display screen.

4. The method of claim 2, wherein the line-form advertising part has a thickness less than a regular thickness.

5. The method of claim 4, wherein in the extracting the line-form advertising part, a morphology closing operation and an image differentiating technique are used.

6. The method of claim 2, wherein in the obtaining a third image, a two-dimensional code or a three-dimensional code attached on the advertising board is used.

7. The method of claim 2, further comprising:
extracting edges of each adverting board, when a plurality of advertising boards are connected to each other; and
regarding the extracted edges as the background part and removing the background part, when a color of the extracted edges is identical to a predetermined color.

8. A method of generating mixed reality contents, comprising:
converting an advertisement display image into a background part formed of a third color, based on a preset input signal;
generating a fifth image after capturing an object with the background part in a background;
extracting and removing the background part from the fifth image;
obtaining a sixth image, in which the background part is removed;
obtaining a seventh image, which is a background image, based on an input; and
generating an eighth image by combining the sixth image with the seventh image.

9. An apparatus for generating mixed reality contents, comprising:
an image obtaining unit for generating a first image after capturing an object with an advertising board that includes a background part formed of a first color and a line-form advertising part formed of a second color in a background; and
a background part extraction unit for extracting and removing the background part from the first image, extracting the line-form advertising part, regarding the extracted line-form advertising part as the background part, and removing the line-form advertising part when the second color is identical to a predetermined color,
wherein the image obtaining unit obtains a second image, in which the background part and the advertising part are removed.

10. The apparatus of claim 9, further comprising:
a background image obtaining unit for obtaining a third image, which is a background image, based on an input; and
a controller for generating a fourth image by combining the second image with the third image.

11. The apparatus of claim 10, wherein the controller converts the background part into the first color based on a preset input signal, when the advertising board is a display screen.

12. The apparatus of claim 10, wherein the advertising part has a thickness less than a regular thickness.

13. The apparatus of claim 12, wherein the background part extraction unit extracts the line-form advertising part using a morphology closing operation and an image differentiating technique.

14. The apparatus of claim 10, wherein the background image obtaining unit obtains the third image using a two-dimensional code or a three-dimensional code attached on the advertising board.

15. The apparatus of claim 10, wherein the background part extraction unit extracts edges of each adverting board, when a plurality of advertising boards are connected to each other, regards the extracted edges as the background part and removes the background part, when a color of the extracted edges is identical to a predetermined color.

16. An apparatus for generating mixed reality contents, comprising:
a controller for converting an advertisement display image into a background part formed of a third color only, based on a preset input signal;
an image obtaining unit for generating a fifth image after capturing an object with the background part in a background;
a background part extraction unit for extracting and removing the background part from the fifth image and obtaining a sixth image, in which the background part is removed; and
a background image obtaining unit for obtaining a seventh image, which is a background image, based on an input,
wherein the controller generates an eighth image by combining the sixth image with the seventh image.
